(19) United States
(12) Patent Application Publication
(10) Pub. No.: US 2011/0128255 A1
(43) Pub. Date: Jun. 2, 2011

(54) LIGHT SOURCE MODULE AND OPTICAL TOUCH APPARATUS

(75) Inventors: Hua-Te Feng, Hsin-Chu (TW); Chia-Hung Yu, Hsin-Chu (TW)

(73) Assignee: CORETRONIC CORPORATION, Hsin-Chu (TW)

(21) Appl. No.: 12/876,236

(22) Filed: Sep. 6, 2010

(30) Foreign Application Priority Data
Nov. 27, 2009 (TW) 98140659

(51) Int. Cl. G06F 3/042; F21V 7/22

(52) U.S. Cl. 345/175; 362/606

(57) ABSTRACT

A light source module includes a light source, a light guide unit, an opaque reflective element, a reflective unit, and a patterned light-absorbing element. The light guide unit has first and second surfaces, a light incident surface, and third and fourth surfaces. A beam from the light source enters the light guide unit through the light incident surface and is transmitted to outside through the first surface. The opaque reflective element covers a portion of the first surface adjacent to the light incident surface. The patterned light-absorbing element is disposed on a surface of the reflective unit. A portion of the patterned light-absorbing element is between a portion of the third surface adjacent to the light incident surface and the reflective unit. Another portion of the patterned light-absorbing element is between a portion of the fourth surface adjacent to the light incident surface and the reflective unit.

### CROSS-REFERENCE TO RELATED APPLICATION

This application claims the priority benefit of Taiwan application serial no. 98140659, filed on Nov. 27, 2009. The entirety of the above-mentioned patent application is hereby incorporated by reference herein and made a part of this specification.

### BACKGROUND OF THE INVENTION

1. Field of the Invention

The invention relates to a light source and a touch apparatus, and in particular to a light source module and an optical touch apparatus.

2. Description of Related Art

As information techniques using wireless mobile communication and information appliances have rapidly developed, to achieve more convenience, more compact and light volume, and more user-friendly designs, various information products have changed from using conventional input devices such as key boards or the mouse to using touch panels. Some touch panels are now even attached to display devices to form touch panel display devices. Currently, touch panels are roughly classified into resistive, capacitive, optical, acoustic wave, and electromagnetic touch panels, as well as other types. Taking the optical touch panel as an example, the optical touch panel usually includes a light source, a light guide module, a sensing device, and a panel.

Taiwan Patent Publication No. 200700797 and Taiwan Patent No. 592309 respectively disclose a light emitting module having a light-absorbing material and a surface light source device so as to enhance the uniformity of the surface light source at a light emitting surface. In addition, Taiwan Patent Publication No. 200811538 discloses a light guide plate having a reflective coating or a reflective sheet.

Besides, Taiwan Patent Publication No. 200841227 discloses an optical touch apparatus including a light source, a light guide module, and an image sensing module. The light source emits light beam into the light guide module, and the light guide module is used to transmit a moving state of an input device to the image sensing module. Moreover, Taiwan Patent Application No. 98129124 discloses an optical touch device, wherein a light guide bar, an invisible light source, and a light sensing device are disposed beside at least one side of a screen.

### SUMMARY OF THE INVENTION

The invention provides a light source module capable of providing light with uniform light emitting intensity.

The invention provides an optical touch apparatus having high accuracy in determining a touch position.

Other objects and advantages of the invention may be further comprehended by reading the technical features described in the invention as follows.

In order to achieve at least one of the above advantages or other advantages, an embodiment of the invention provides a light source module including at least one light source, a light guide unit, an opaque reflective element, a reflective unit, and a patterned light-absorbing element. The light source is capable of providing a beam. The light guide unit is disposed in a transmission path of the beam. Besides, the light guide unit has a first surface, a second surface, an incident surface, a third surface, and a fourth surface. The second surface is opposite to the first surface. The light incident surface is connected with the first surface and the second surface. The beam is capable of entering the light guide unit through the light incident surface and is transmitted to outside of the light guide unit through the first surface. The third surface is connected with the light incident surface, the first surface, and the second surface. The fourth surface is opposite to the third surface and connected with the light incident surface, the first surface, and the second surface. The opaque reflective element covers a portion of the first surface adjacent to the light incident surface. The reflective unit is disposed on the second surface, the third surface, and fourth surface. The patterned light-absorbing element is disposed on a surface of the reflective unit. A portion of the patterned light-absorbing element is located between a portion of the third surface adjacent to the light incident surface and the reflective unit, and another portion of the patterned light-absorbing element is located between a portion of the fourth surface adjacent to the light incident surface and the reflective unit.

Another embodiment of the invention provides an optical touch apparatus adapted to a display apparatus having a display area. The optical touch apparatus includes at least one optical detector and the optical touch apparatus mentioned above. The optical detector is disposed beside the display area and detects an intensity variation of the beam in the sensing space.

Based on the above, the embodiment of the invention has at least one of the following advantages. By adopting the opaque reflective element covering the light guide unit, the strong intensity of a portion of the beam passing through the first surface adjacent to the light incident surface is shielded. Besides, the embodiment of the invention also adopts the patterned light-absorbing element on the surface of the reflective unit so as to reduce the strong intensity of a portion of the beam passing through the first surface adjacent to the light incident surface. Thus, the light emitting intensity of the beam transmitted from the light guide unit is uniform, such that the optical touch apparatus is capable of determining a touch position accurately.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a front view of an optical touch apparatus and a display apparatus in an embodiment of the invention.

FIG. 2 is a schematic cross-sectional view of the optical touch apparatus and a display apparatus along line I-I of FIG. 1.

FIG. 3 is a perspective schematic view of the light guide unit and an opaque reflective element of FIG. 1.

FIG. 4 is a top view of the light guide unit and the light source along x-direction of FIG. 3.

FIG. 5A is a schematic view illustrating the structure of a light source module in an embodiment of the invention.

FIG. 5B is a schematic cross-sectional view illustrating the light source module along line II-II of FIG. 5A.

FIG. 5C is a top view illustrating a reflective sheet of the reflective unit along the −z-direction of FIG. 5A and FIG. 5B.

FIG. 6A is a light emitting intensity curve diagram of a light source module without adopting the opaque reflective element, the patterned light-absorbing element, and the light-absorbing element.

FIG. 6B is a light emitting intensity curve diagram of a light source module in an embodiment of the invention.

FIG. 7 is a schematic cross-sectional view of a light source module in another embodiment of the invention.

FIG. 8 is a schematic cross-sectional view of a light source module in another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

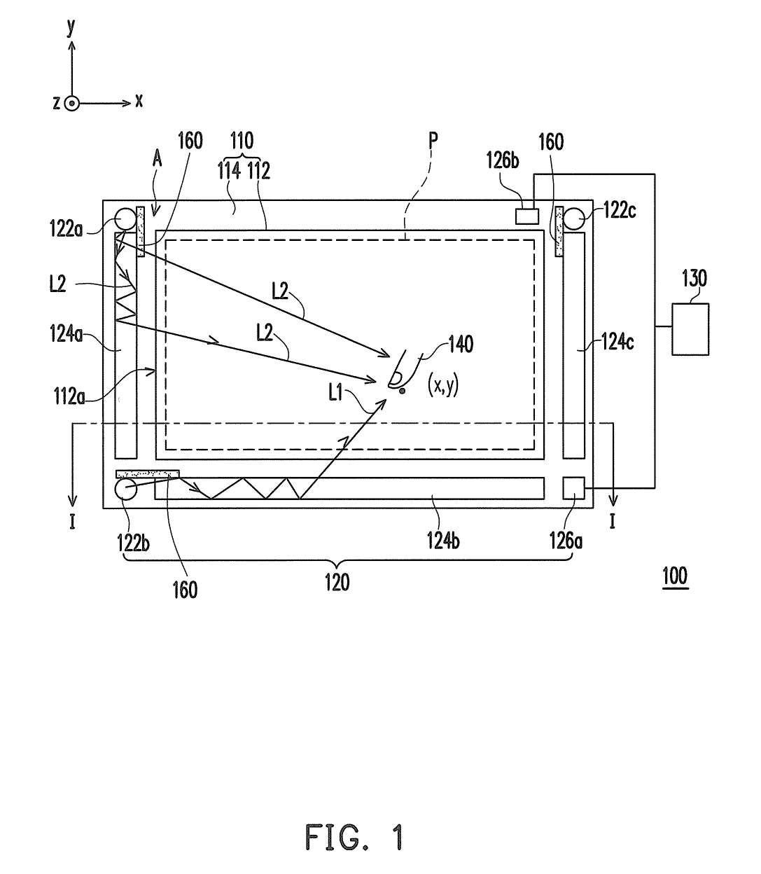

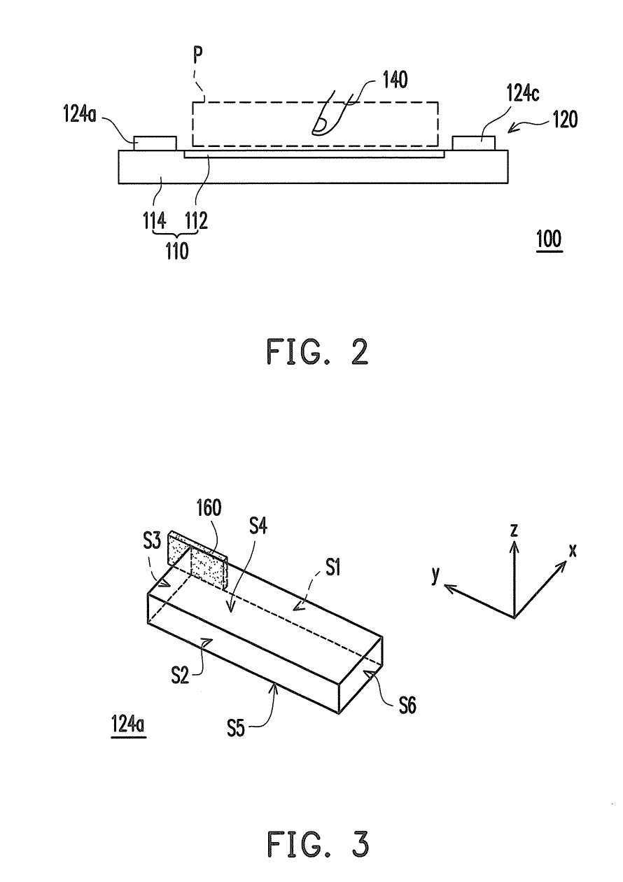

Referring to both FIGS. 1 and 2, an optical touch apparatus 120 of the embodiment is adapted to a display apparatus 110, and the optical touch apparatus 120 and a display apparatus 110 may constitute an optical touch display apparatus 100. The display apparatus 110 has a display area 112, wherein a sensing space P is in front of the display area 112. Besides, the display apparatus 110 further includes an external frame 114. In the embodiment, the display area 112 is disposed in the external frame 114 and the optical touch apparatus 120 is disposed on the external frame 114.

As shown in FIG. 1, the optical touch apparatus 120 includes at least one light source 122b, at least one light guide unit 124b, and at least one optical detector 126a. The light source 122b is disposed beside the display area 112 and capable of providing a beam L1. In the embodiment, the beam L1 is, for example, invisible light and the light source 122b is an infrared ray light emitting diode (IR-LED), for example.

Referring to FIG. 1, the light guide unit 124b is disposed in a transmission path of the beam L1. On the other hand, the optical touch apparatus 120 of the embodiment includes a plurality of light sources, e.g. light sources 122a˜122c (three are schematically shown in FIG. 1). The optical detector 126a is disposed beside the display area 112 to sense an intensity variation of a beam (e.g. a beam L2) in the sensing space P. Moreover, the optical touch apparatus 120 further includes a plurality of light guide units and a plurality of optical detectors, for example, light guide units 124a˜124c (three are schematically shown in FIG. 1) and optical detectors 126a and 126b (two are schematically shown in FIG. 1). The light guide units 124a˜124c are disposed at different sides of the display area 112 corresponding to the light sources 122a˜122c, respectively. Each of the optical detectors 126a˜126b is disposed beside the display area 112 facing one of the light guide units 124a˜124c. Specifically, the optical detector 126a is disposed beside the display area 112 facing the light guide unit 124a, and the optical detector 126b is disposed beside the display area 112 facing the light guide unit 124b. The optical detector 126a senses, for example, an intensity variation of the beam L2 along y-direction transmitted from the light guide unit 124a. The optical detector 126b senses, for example, an intensity variation of the beam L1 along x-direction transmitted from the light guide unit 124b.

Furthermore, the optical touch apparatus 120 of the embodiment further includes a processing unit 130 electronically connected with the optical detector 126a or the optical detector 126b. Referring to both FIG. 1 and FIG. 2, when a touch object 140 (e.g. a finger) enters the sensing space P, the processing unit 130 determines a position (x, y) of the touch object 140 relative to the display area 112 according to the intensity variations of the beam transmitted from the light guide unit corresponding to different directions.

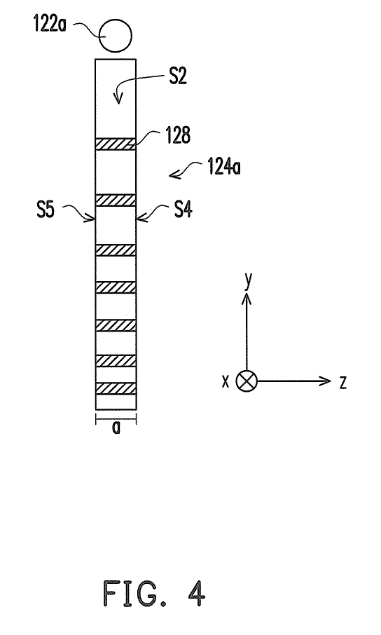

As shown in FIG. 3, the light guide unit 124a has a surface S1, a surface S2, and a light incident surface S3. The surface S2 is opposite to the surface S1. The light incident surface S3 is connected with the surface S1 and the surface S2. Referring to both FIG. 1 and FIG. 3, the beam L2 from the light source 122a enters the light guide unit 124a through the light incident surface S3 and is transmitted to the sensing space P in front of the display area 112 through the surface S1. In other words, in the embodiment, the surface S1 of the light guide unit 124a is a light emitting surface.

Moreover, the light guide unit 124a of the embodiment further has a surface S4, a surface S5, and a surface S6. As shown in FIG. 3, the surface S4 of the light guide unit 124a is connected with the light incident surface S3, the surface S1, and the surface S2. The surface S5 is opposite to the surface S4 and connected with the light incident surface S3, the surface S1, and the surface S2. On the other hand, the surface S6 is opposite to the light incident surface S3.

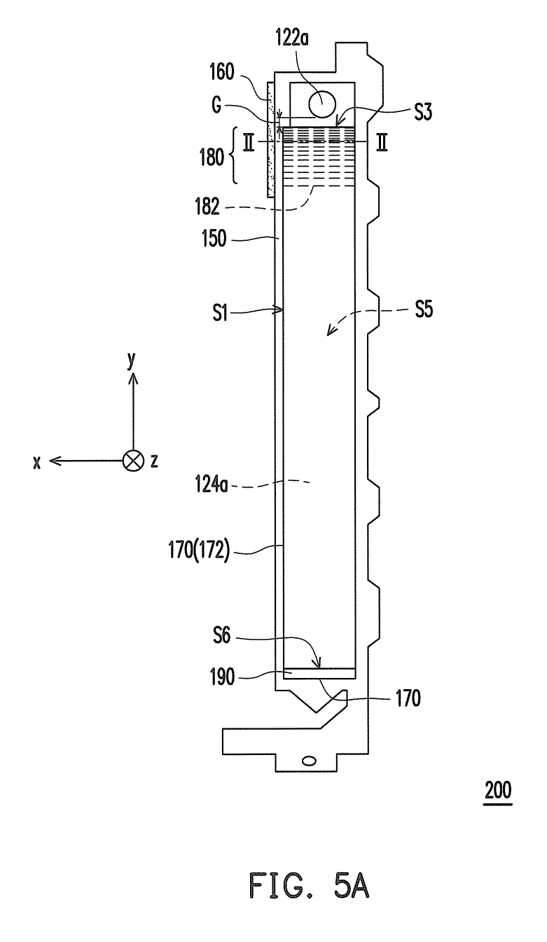

As shown in FIG. 4A, the surface S2 has a plurality of microstructures 128. A number density of the microstructures 128 close to the light source 122a is less than a number density of the microstructures 128 away from the light source 122a. Besides, the microstructures 128 are, for example, printing dots or etching dots. The printing dots are, for example, protruding points or protruding patterns. The etching dots are, for example, recessions or grooves. The beam L2 of FIG. 1 is able to emit uniformly from the light emitting surface (i.e. surface S1) of the light guide unit 124a by adjusting the number density of the microstructures 128 on the surface S2, such that the light guide unit 124a is capable of providing a uniform light source along the y-direction. The width a of the light guide unit 124a along the z-direction may be reduced so as to enhance the thinness of the optical touch apparatus 120.

Moreover, the surface S4, the surface S5, and the surface S6 (shown in FIG. 3) of the light guide unit 124a may have the above-mentioned microstructures 128 in another embodiment. In other words, in another embodiment, at least one of the surface S2, the surface S4, the surface S5, and the surface S6 has a plurality of microstructures 128 so as to enhance the uniformity of the irradiance of the beam L2 at the light emitting surface (i.e. surface S1) of the light guide unit 124a along the y-direction. On the other hand, the light guide units 124b and 124c of FIG. 1 may have the same structures as the structure of the light guide unit 124a. Thus, the light guide units 124b and 124c may respectively provide uniform light sources at other two sides of the display area 112, such that the uniformity of the irradiance in the sensing space P is able to be enhanced as well. Herein, the irradiance (W/m²) is power of light irradiating on a unit area per unit time. The structures of the light guide units 124b and 124c of the embodiment may be referred to the structure of the light guide unit 124a. Therefore, no further description is provided hereinafter.

Referring to both FIG. 1 and FIG. 3, in the embodiment, the light source 122a is disposed at a corner A of the display area 112, and the light guide unit 124a is disposed at a side 112a of the display area 112. In addition, the surface S1 faces towards the sensing space P. When the touch object 140 enters the sensing space P, the touch object 140 shields off a portion of the beam L2 transmitted from the light guide unit 124a, such that the optical detector 126a senses an intensity variation of the beam L2 along the y-direction. In other words, the optical detector 126a senses a dark point along the y-direction, such that the coordinate y of a touch position is determined according to the dark point. Similarly, the touch object 140 also shields off a portion of the beam L1 transmitted from the light guide unit 124b, such that the optical detector 126b senses another intensity variation of the beam L1 along the x-direction. In other words, the optical detector 126b senses a dark point along the x-direction, such that the coordinate x of the touch position is determined according to the dark point. Then, the processing unit 130 determines the position (x, y) of the touch object 140 relative to the display area 112 according to the intensity variations along the two directions.

By properly rotating the optical detector 126b, the optical detector 126b is able to sense the intensity variation of beam L2 transmitted from the light guide unit 124a along the y-direction in the sensing space P. In other words, in another embodiment, the optical detector 126a and the optical detector 126b may be able to respectively sense the intensity variations along the x-direction and the y-direction in the sensing space P according to the locations of the optical detector 126a and the optical detector 126b and the direction they face. Thus, the position (x, y) of the touch object 140 is determined according to the intensity variations along different directions respectively sensed by the optical detector 126a and the optical detector 126b. In other words, the locations of the optical detector 126a and the optical detector 126b are not limited to the locations as shown in FIG. 1, and may be varied according to the actual requirements.

In general, when the light source 122a and the light guide unit 124a is disposed, the intensity of the beam L2 transmitted from a portion of the surface S1 adjacent to the light incident surface S3 is stronger which results in non-uniform light emitting intensity of the beam L2 emitted from the surface S1. As a result, the accuracy of the optical detector 126a is affected. To solve the problem, in the embodiment, an opaque reflective element 160 is adopted and disposed beside each of the light guide units 124a, 124b, and 124c so as to shield off the portion of the beams with strong intensity passing through the portion of the surface S1 adjacent to the light incident surface S3 (shown in FIG. 3). In this way, the light emitting intensity of the beam transmitted from the light guide unit 124a, 124b, and 124c is uniform, such that the optical touch apparatus is capable of determining the touch position accurately.

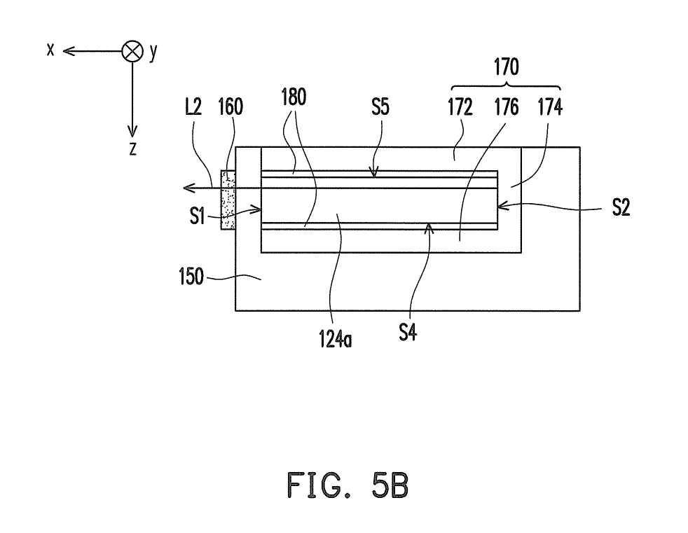

Referring to both FIG. 5A and FIG. 5B, the light source module 200 of the embodiment includes the above-mentioned light source 122a, the above-mentioned light guide unit 124a, the above-mentioned opaque reflective element 160, a reflective unit 170, a patterned light-absorbing element 180, and a front frame 150. The light source module 200 of the embodiment is similar to a combination of the light guide unit 124a, the light source 122a, and the opaque reflective element 160 of FIG. 1. Besides, the light source module 200 is able to substitute for the combination of the light guide unit 124a, the light source 122a, and the opaque reflective element 160 so as to form different types of optical touch apparatuses and optical touch display apparatuses. The difference between the structure of the light source module 200 of the embodiment and the structure depicted in FIG. 1 may be demonstrated hereinafter. To be easily read by a user, the light guide unit 124a of FIGS. 5A and 5B is depicted as the light guide unit 124a of FIG. 1 seen along the +z-direction. However, each of the corresponding relations between the surfaces of the light guide unit 124a and the x, y, and z directions may be adjusted according to the position of the light guide unit 124a relative to the display area 112 or actual requirements, and the invention is not limited to FIG. 1, FIG. 5A, and FIG. 5B.

The front frame 150 of the embodiment covers a portion of surfaces of the light guide unit 124a. In the embodiment, the front frame 150 covers, for example, the light incident surface S3, the surface S1, the surface S2, the surface S4, and the surface S6. However, in another embodiment, the front frame 150 may cover at least one of the light incident surface S3, the surface S1, the surface S2, the surface S4, and the surface S6. The beam L2 is capable of passing through the front frame 150. A color master may be added into the front frame 150 such that the front frame 150 is non-transparent. Thus, the artistry-featuring look of the optical touch display apparatus 100 is enhanced. An infrared ray is able to pass through the color master mentioned above. That is to say, the beam L2 is capable of passing through the front frame 150 to the sensing space P of FIG. 1, such that the sensing function of the optical detectors 126a and 126b are not affected. Furthermore, in the embodiment, the front frame 150 is disposed between the surface S1 and the opaque reflective element 160, and the front frame 150 covers at least the surface S1. On the other hand, in order to prevent the optical detectors 126a and 126b from directly sensing the beam of the light source 112a, 112b, and 112c from light emitting surfaces thereof to further result in reducing the accuracy of the optical detectors 126a and 126b, the opaque reflective element 160 of FIG. 5A not only covers the portion of the surface S1 adjacent to the light incident surface S3, but also a gap G between the light sources 112a and 112b and the light incident surface S3. Moreover, the opaque reflective element 160 of the embodiment is a metal foil, e.g. an aluminum foil.

Besides, as shown in FIG. 5B, the patterned light-absorbing element 180 is disposed on a surface of the reflective unit 170. Furthermore, the reflective unit 170 of the light source module 200 covers at least one of the surface S2, the surface S4, the surface S5, and the surface S6 (shown in FIG. 3). In the embodiment, the reflective unit 170 covers the surface S2, the surface S4, and the surface S5. Specifically, the reflective unit 170 includes reflective sheets 172, 174, and 176 respectively covering the surfaces S5, S2 and S4.

As shown in FIGS. 5A and 5B, a portion of the patterned light-absorbing element 180 is located between a portion of the surface S5 adjacent to the light incident surface S3 and the reflective unit 170 (i.e. the reflective sheet 172), and another portion of the patterned light-absorbing element 180 is located between a portion of the surface S4 (opposite to surface S5) adjacent to the light incident surface S3 and the reflective unit 170 (the reflective sheet 176). In addition, as shown in FIG. 5C, a pattern density of the patterned light-absorbing element 180 at a position close to the light source 122a is greater than a pattern density of the patterned light-absorbing element 180 at a position away from the light source 122a, wherein the pattern density is an area of the pattern per unit area. For example, the patterned light-absorbing element 180 includes a plurality of line structures 182 arranged along a direction (i.e. the y-direction) substantially perpendicular to the light incident surface S3, and each of the line structures 182 extends along a direction (i.e. the x-direction) substantially parallel to the light incident surface S3. Here, the pattern density represents the number of the line structures per unit area. In addition, patterns of the patterned light-absorbing element 180 between a portion of the surface S4 (opposite to surface S5) adjacent to the light incident surface S3 and the reflective unit 170 (reflective sheet 176) may be referred to FIG. 5C, and no further description is provided hereinafter.

In general, the intensity of the beams L1 and L2 transmitted from the portion of the surface S1 adjacent to the light incident surface S3 of the light guide unit 124a, 124b, or 124c is so stronger that the light emitting intensity is non-uniform. As a result, the accuracy of the optical detectors 126a and 126b is affected. To solve the problem, in the embodiment, the opaque reflective element 160 is adopted to shield off the portion of the beams L1 and L2 with strong intensity passing through the portion of the surface S1 adjacent to the light incident surface S3. Besides, by adopting the patterned light-absorbing element 180 disposed between the portion of the surfaces S4 and S5 adjacent to the surface S3 and the reflective unit 170, the intensity of the beams L1 and L2 transmitted from the portion of the surface S1 adjacent the light incident surface S3 may be reduced. In the embodiment, the patterned light-absorbing element 180 is, for example, a patterned coating on the surface of the reflective unit 170. The coating may be a paint including a pigment able to shield off at least a portion of the beams L1 and L2. As a result, the intensity of the beams L1 and L2 transmitted from the portion of the surface S1 adjacent to the light incident surface S3 of the light guide unit 124a, 124b, or 124c is close to the intensity of the beams L1 and L2 transmitted from another portion of the surface S1, such that the uniformity of the overall light emitting and the accuracy of the optical detectors 126a and 126b is enhanced. Thus, the accuracy of the optical touch apparatus 120 in determining the touch position is increased.

Besides, as shown in FIG. 5A, the light source module 200 of the embodiment further includes a light-absorbing element 190 disposed between the surface S6 and the reflective unit 170. Thus, the intensity of the beams L1 and L2 transmitted from the portion of the surface S1 adjacent to the surface S6 of the light guide unit 124a, 124b, and 124c is reduced, such that the overall light supplied by the light source module 200 may be more uniform. The light-absorbing element 190 is, for example, a coating on the reflective unit 170. The function of the light-absorbing element 190 is the same as the function of the patterned light-absorbing element 180, and thus no further description is described hereinafter. Moreover, in another embodiment, the optical touch apparatus 120 and the light source module 200 may not have the light-absorbing element 190. In another embodiment, when the lengths of the light guide unit 124a, 124b, and 124c are long enough so that the intensity transmitted from the portion of the surface S1 adjacent surface S6 is not too strong, there is no need to adopt the light-absorbing element 190.

Since the light source module 200 of the embodiment has the patterned light-absorbing element 180 and the light-absorbing element 190, the intensity of the beam L2 transmitted from the surface S1 adjacent to the light incident surface S3 of the light guide unit 124a and the intensity of the beam L2 transmitted from the surface S1 adjacent to the light incident surface S6 are close to the intensity of the beam L2 transmitted from other portion of the surface 51. As a result, the overall light supplied by the light source module 200 may be uniform, so that the accuracy of the optical detector is enhanced. Figures from experiments are shown below to illustrate the effect of the light source module 200. The light source module 200 of the embodiment is able to replace the combination of the light guide unit 124b, the light source 122b, and the opaque reflective element 160 in FIG. 1, and further may replace the combination of the light guide unit 124c, the light source 122c, and opaque reflective element 160 in FIG. 1. The directions the surfaces of the light guide unit 124a of the light source module 200 respectively face are required to be adjusted correspondingly, so that the surface S1 faces the sensing space P and the light incident surface S3 faces the light sources (e.g. the light source 122b or the light source 122c).

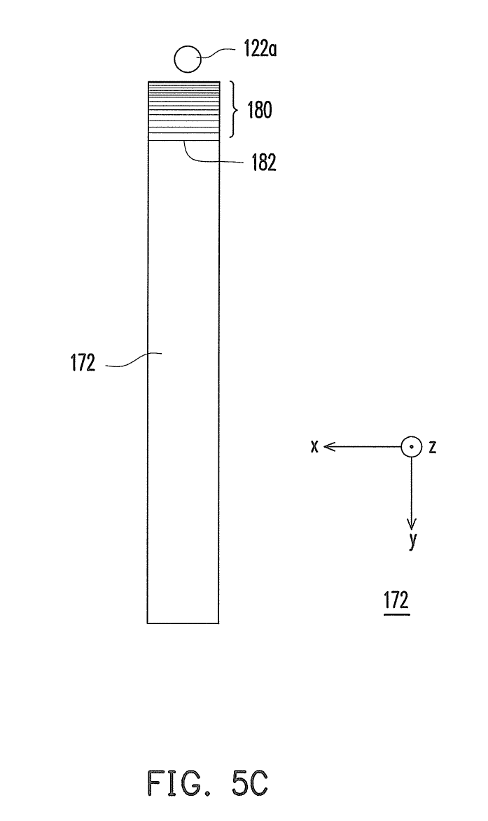

Referring to FIGS. 6A and 6B, the horizontal axis represents a position of the light guide unit along the y-direction (i.e. the extending direction of the light guide unit 124a), and the vertical axis represents the intensity of the beam L2 transmitted from the surface S1. As shown in FIG. 6A, the intensity of the beam L2 transmitted from two ends of the surface S1 (i.e. portions adjacent to the light incident surface S3 and the surface S6) is too strong since the opaque reflective element 160, the patterned light-absorbing element 180, and the light-absorbing element 190 are not adopted. As a result, the accuracy of the optical detectors is affected. Referring to FIG. 6B, because the light source module 200 of the embodiment adopts the opaque reflective element 160, the patterned light-absorbing element 180, and the light-absorbing element 190, the total light emitting intensity may be uniform, so that the optical detectors are capable of determining the touch position precisely.

When the length of the light guide unit 124a along y-direction is long enough, the patterned light-absorbing element 180 may be adopted alone without the light-absorbing element 190 being adopted.

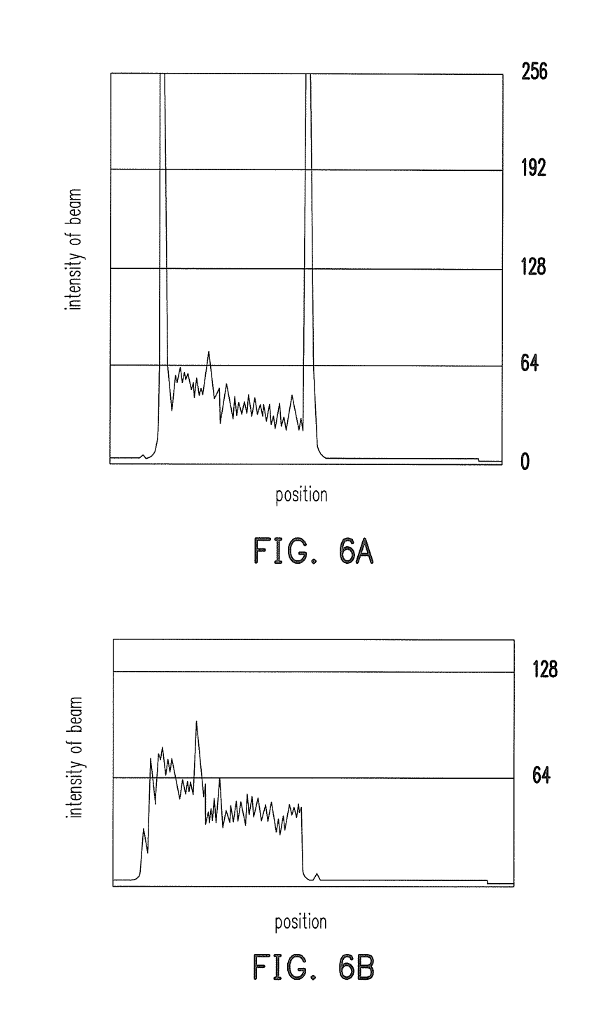

Referring to FIG. 7, the light source module 200a of the embodiment is similar to the light source module 200 in FIG. 5B, and the difference between these two light source modules is described as below. In the embodiment, the opaque reflective element 160 of the light source module 200a is disposed between the surface S1 and the front frame 150a. Besides, the opaque reflective element 160 of the embodiment is a metal foil disposed on a surface of the front frame 150a.

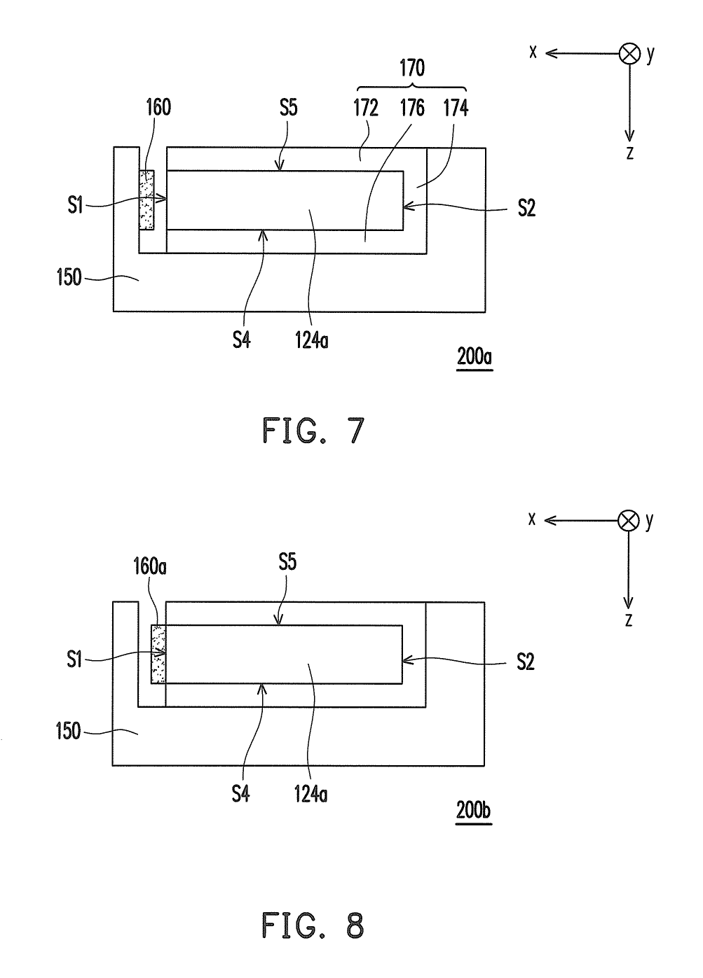

Referring to FIG. 8, the light source module 200b of the embodiment is similar to the light source module 200a of FIG. 7, while the difference between these two light source modules lies in that the opaque reflective element 160 of the light source module 200b is a metal foil disposed on the surface S1 of the light guide unit 124a.

In conclusion, the embodiments of the invention include at least one of the following advantages. Since the opaque reflective element covering the light guide unit is adopted to shield off a portion of the beam with high intensity transmitted from the surface S1 adjacent to the light incident surface, and the patterned light-absorbing element on the surface of the reflective unit is also used to reduce the strong intensity of a portion of the beam passing through the surface 51 adjacent to the light incident surface, the light emitting intensity provided by the light guide unit may be uniform, such that the optical touch apparatus is capable of determining a touch position accurately. Besides, the embodiments of the invention may further dispose the light-absorbing element between the surface S6 and the reflective unit to reduce the intensity of a portion of the beam transmitted from the surface S1 adjacent the surface S6, so that the overall light supplied by the light guide unit may be more uniform.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module, comprising:
at least one light source, capable of providing a beam; a light guide unit, disposed in a transmission path of the beam, and the light guide unit having:
a first surface;
a second surface, opposite to the first surface;
a light incident surface, connected with the first surface and the second surface, and the beam being capable of entering the light guide unit through the light incident surface and being transmitted to outside of the light guide unit through the first surface; a third surface, connected with the light incident surface, the first surface, and the second surface; and a fourth surface, opposite to the third surface and connected with the light incident surface, the first surface, and the second surface;
an opaque reflective element, covering a portion of the first surface adjacent to the light incident surface; a reflective unit, disposed on the second surface, the third surface, and fourth surface; and a patterned light-absorbing element, disposed on a surface of the reflective unit, wherein a portion of the patterned light-absorbing element is located between a portion of the third surface adjacent to the light incident surface and the reflective unit, and another portion of the patterned light-absorbing element is located between a portion of the fourth surface adjacent to the light incident surface and the reflective unit.

2. The light source module of claim 1, wherein a pattern density of the patterned light-absorbing element at a position close to the light source is greater than a density of the patterned light-absorbing element at a position away from the light source.

3. The light source module of claim 1, wherein the opaque reflective element further covers a gap between the light source and the light incident surface.

4. The light source module of claim 1, wherein the opaque reflective element further coves the light source.

5. The light source module of claim 1, further comprising a light-absorbing element, and the light guide unit further comprising a fifth surface, the fifth surface is opposite to the light incident surface and connected with the first surface, the second surface, the third surface, and the fourth surface, wherein the light-absorbing element is disposed between the fifth surface and the reflective unit.

6. The light source module of claim 1, further comprising a front frame covering a portion of surface of the light guide unit, wherein the beam is capable of passing through the front frame, and the opaque reflective element is disposed on at least one of the front frame and the light guide unit.

7. The light source module of claim 1, wherein the patterned light-absorbing element is a patterned coating on the surface of the reflective unit.

8. The light source module of claim 1, wherein the patterned light-absorbing element comprises a plurality of line structures, the line structures are arranged along a direction substantially perpendicular to the light incident surface, and each of the line structures extends along a direction substantially parallel to the light incident surface.

9. The light source module of claim 1, wherein the opaque reflective element is a metal foil.

10. An optical touch apparatus, adapted to a display apparatus, the display apparatus having a display area, and the optical touch apparatus comprising:
at least one light source, disposed beside the display area and suitable for providing a beam; at least one light guide unit, disposed beside the display area and in a transmission path of the beam, the light guide unit having:
a first surface;
a second surface, opposite to the first surface;
a light incident surface, connected with the first surface and the second surface, and the beam being capable of entering the light guide unit through the light incident surface and being transmitted to a sensing space in front of the display area through the first surface; a third surface, connected with the light incident surface, the first surface, and the second surface; and a fourth surface, opposite to the third surface and connected with the light incident surface, the first surface, and the second surface;
at least one optical detector, disposed beside the display area and capable of detecting an intensity variation of the beam in the sensing space; an opaque reflective element, covering a portion of the first surface adjacent to the light incident surface; a reflective unit, disposed on the second surface, the third surface, and fourth surface; and a patterned light-absorbing element, disposed on a surface of the reflective unit, wherein a portion of the patterned light-absorbing element is located between a portion of the third surface adjacent to the light incident surface and the reflective unit, and another portion of the patterned light-absorbing element is located between a portion of the fourth surface adjacent to the light incident surface and the reflective unit.

11. The optical touch apparatus of claim 10, wherein a pattern density of the patterned light-absorbing element at a position close to the light source is greater than a density of the patterned light-absorbing element at a position away from the light source.

12. The optical touch apparatus of claim 10, wherein the opaque reflective element further covers a gap between the light source and the light incident surface.

13. The optical touch apparatus of claim 10, further comprising a light-absorbing element, and the light guide unit further comprising a fifth surface, the fifth surface is opposite to the light incident surface and connected with the first surface, the second surface, the third surface, and the fourth surface, wherein the light-absorbing element is disposed between the fifth surface and the reflective unit.

14. The optical touch apparatus of claim 10, wherein the patterned light-absorbing element is a patterned coating on the surface of the reflective unit.

15. The optical touch apparatus of claim 10, wherein the patterned light-absorbing element comprises a plurality of line structures, the line structures are arranged along a direction substantially perpendicular to the light incident surface, and each of the line structures extends along a direction substantially parallel to the light incident surface.

16. The optical touch apparatus of claim 10, wherein the opaque reflective element is a metal foil.

17. The optical touch apparatus of claim 10, further comprising a front frame covering a portion of surface of the light guide unit, wherein the beam is capable of passing through the front frame.

18. The optical touch apparatus of claim 17, wherein the front frame covers at least the first surface of the light guide unit, and the opaque reflective element is disposed on at least one of the front frame and the light guide unit.
